(19) United States
(12) Patent Application Publication
(10) Pub. No.: US 2006/0188207 A1
(43) Pub. Date: Aug. 24, 2006

(54) Planar lightwave circuit with an optical protection layer and integrated optical circuit using the same

(75) Inventors: Sun-Tae Jung, Anyang-si (KR); Jae-Geol Cho, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/358,682

(22) Filed: Feb. 21, 2006

(30) Foreign Application Priority Data
Feb. 21, 2005 (KR) 14245/2005

(51) Int. Cl. G02B 6/10

(52) U.S. Cl. 385/129; 385/14

(57) ABSTRACT

A planar lightwave circuit having a core, a clad stacked on the core covering the core to confine light within the core, and an optical protection layer stacked on the clad covers the clad is disclosed. The clad has a lower refractive index than the core. The optical protection layer is made of a material for absorbing the light leaked from the core to the clad.

### CLAIM OF PRIORITY

This application claims priority under 35 U.S.C. § 119 to an application entitled “Planar Lightwave Circuit with an Optical Protection Layer and Integrated Optical Circuit Using the Same,” filed in the Korean Intellectual Property Office on Feb. 21, 2005 and assigned Ser. No. 2005-14245, the contents of which are incorporated herein by reference.

### BACKGROUND OF THE INVENTION

1. Field of the Invention

The present invention generally relates to an integrated optical circuit for use in an optical communication system, and more particularly to a planar lightwave circuit (PLC) having a core serving as a light propagation medium.

2. Description of the Related Art

In an integrated optical circuit, passive devices such as a mirror, lens, thin film filter, and electrodes are integrated on a planar lightwave circuit (PLC). The PLC is provided with a straight or curved line type core for propagating light from one end to another or a core designed to perform a filter function using optical wavelength characteristics. The integrated optical circuit can be used as a switch, attenuator, and so on by varying the refractive index of the core via an electric field or temperature.

In the integrated optical circuit, active devices such as a laser diode (LD), photodiode (PD), and so on can be integrated on the PLC using a hybrid integration or monolithic integration process to enable many functions to be implemented in a small size and at low cost.

FIG. 1 is a block diagram illustrating a conventional integrated optical circuit, and FIG. 2 is a sectional view of a PLC provided in the integrated optical circuit shown in FIG. 1.

The integrated optical circuit 100 is used as a bi-directional optical transceiver that outputs a first optical signal λ₁ and receives a second optical signal λ₂ to perform an optical-to-electrical (O/E) conversion of the received optical signal λ₂. The integrated optical circuit 100 is provided with a PLC 110, and an LD 150, a PD 160 and a thin film filter 170 integrated thereon. In the integrated optical circuit 100, the first and second optical signals are guided by a core 140 of the PLC 110.

Referring to FIG. 2, the PLC 110 is provided with a substrate 120, a lower clad 130 stacked on the substrate 120, a core 140 serving as a light propagation medium stacked on the lower clad 130, and an upper clad 135 stacked on the lower clad 130 and the core 140 and completely covering the core 140 (or covering an upper surface and both sides of the core 140). To confine the light within the core 140, the lower and upper clads 130 and 135 have a lower refractive index than the core 140. The core is referred to as the optical waveguide.

Referring back to FIG. 1, the first optical signal has a wavelength of 1310 nm and the second optical signal has a wavelength of 1550 nm. The second optical signal input to the core 140 through an external optical fiber passes through the thin film filter 170 and is input to the PD 160. The PD 160 performs an O/E conversion of the input second optical signal and detects an electrical signal. Meanwhile, the first optical signal output from the LD 150 is reflected by the thin film filter 170 and is output to the external optical fiber.

However, the PD 160 may not operate normally due to a crosstalk in the above-described integrated optical circuit 100. That is, the crosstalk occurs when the first optical signal output from the LD 150 is input to the PD 160. As a result, there is a problem in that output noise of the PD 160 increases.

To prevent the crosstalk in the integrated optical circuit 100, a method for forming a structure such as a wall or trench around the PD 160 has been proposed. However, this method requires an additional process which affects the implementation of desirable high integration. Further, there is a problem in that the degree of integration of the overall integrated optical circuit 100 decreases due to a size of the structure itself.

Accordingly, a need exists for an improved method of suppressing the crosstalk in the integrated optical circuit, which may be realized in a simple, reliable, and inexpensive implementation.

### SUMMARY OF THE INVENTION

One aspect of the present invention is to provide a planar lightwave circuit and an integrated optical circuit using the same that can intercept light leaked from a core to a clad.

In one embodiment, there is provided a planar lightwave circuit, which includes: a core serving as a light propagation medium; a clad, stacked on the core, for covering the core to confine light within the core, the clad having a lower refractive index than the core; and an optical protection layer, stacked on the clad, for covering the clad, the optical protection layer being made of a material for absorbing light leaked from the core to the clad.

In another embodiment, there is provided an integrated optical circuit, which includes: a planar lightwave circuit comprising at least one active device integrated therein, the planar lightwave circuit comprising: a core serving as a light propagation medium; a clad, stacked on the core, for covering the core to confine light within the core, the clad having a lower refractive index than the core; and an optical protection layer, stacked on the clad, for covering the clad, the optical protection layer being made of a material for absorbing light leaked from the core to the clad.

### BRIEF DESCRIPTION OF THE DRAWINGS

The above advantages of the present invention will be more clearly understood from the following detailed description taken in conjunction with the accompanying drawings, in which:

FIG. 1 is a block diagram illustrating a conventional integrated optical circuit;

FIG. 2 is a sectional view illustrating a planar lightwave circuit provided in the integrated optical circuit shown in FIG. 1;

FIG. 3 is a block diagram illustrating an integrated optical circuit in accordance with an embodiment of the present invention;

FIG. 4 is a sectional view illustrating a planar lightwave circuit provided in the integrated optical circuit illustrated in FIG. 3; and

FIG. 5 is a sectional view illustrating a planar lightwave circuit in accordance with another embodiment of the present invention.

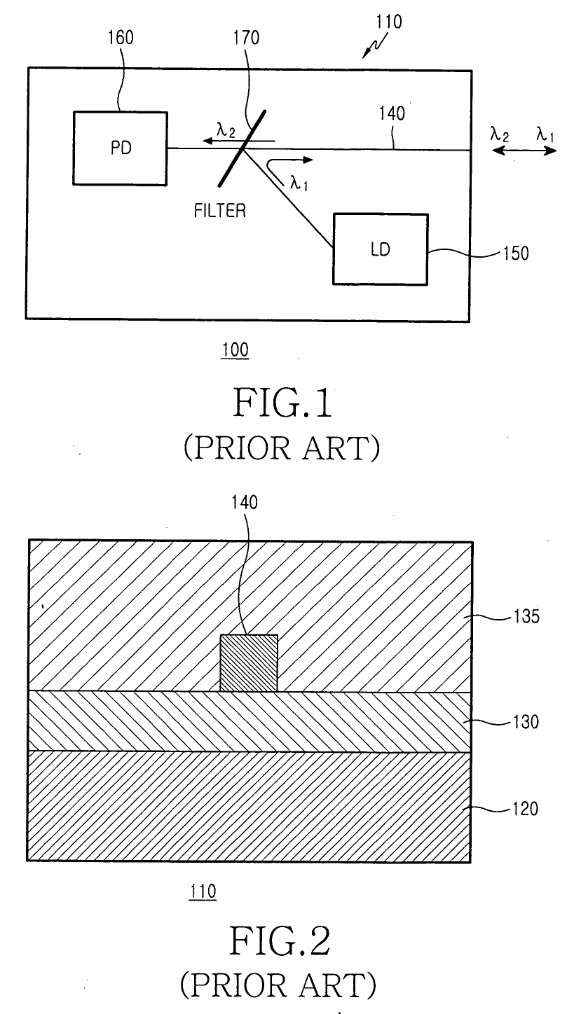

### DETAILED DESCRIPTION

Embodiments of the present invention will be described in detail herein below with reference to the accompanying drawings. For the purposes of clarity and simplicity, detailed descriptions of functions and configurations incorporated herein that are well known to those skilled in the art are omitted.

The present invention utilizes the realization that a crosstalk occurs in an integrated optical circuit when a leakage light propagated to a clad of a planar lightwave circuit (PLC), i.e., light leaked from a core to the clad, is integrated, reflected, or scattered and is input to an active device.

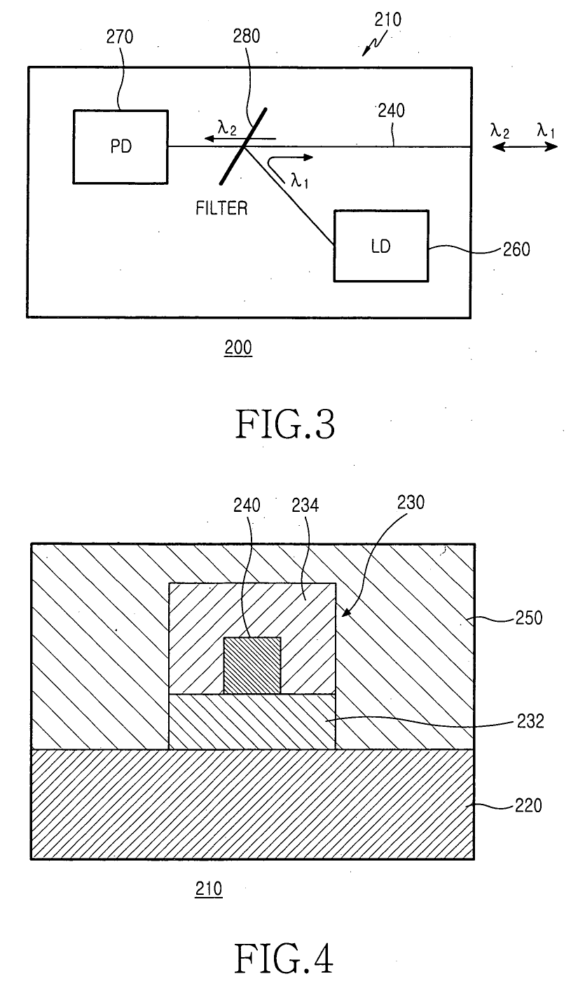

FIG. 3 is a block diagram illustrating an integrated optical circuit in accordance with an embodiment of the present invention, and FIG. 4 is a sectional view illustrating a PLC provided in the integrated optical circuit shown in FIG. 3.

The integrated optical circuit 200 is used as a bi-directional optical transceiver that outputs a first optical signal λ₁ and receives a second optical signal λ₂ to perform an optical-to-electrical (O/E) conversion of the received optical signal λ₂. The integrated optical circuit 200 is provided with a PLC 210, and a laser diode (LD) 260, a photodiode (PD) 270 and a thin film filter 280 integrated thereon.

Referring to FIG. 4, the PLC 210 is provided with a substrate 220, a core 240 serving as a light propagation medium, a clad 230, stacked on the core 240, for completely covering the core 240, and an optical protection layer 250, stacked on the clad 230, for completely covering the clad 230. The clad 230 is stacked on the core 240 and includes lower and upper clads 232 and 234.

The substrate 220 has a flat board shape and may be a conventional semiconductor substrate.

The core 240 is stacked on a lower clad 232 and serves as the light propagation medium. The core 240 is made of a material with low optical loss characteristics. For example, the core 240 may be made of a material in which an inorganic material such as GeO₂, P₂O₅, B₂O₃, or so on for controlling a refractive index is doped with silica (SiO₂), a material containing SiON or silicon, or a material containing an organic material such as an optical polymer, hybrid material, or so on.

The clad 230 is stacked on the core 240 to completely cover (or surround) the core 240 and includes lower and upper clads 232 and 234. The core 240 and the clad 230 are stacked on the substrate 220. To confine the light within the core 240, the lower and upper clads 232 and 234 have a lower refractive index than the core 240. The lower clad 232 is stacked on the substrate 220, and the core 240 is stacked on the lower clad 232. The upper clad 234 is stacked on the core 240 and the lower clad 232 to completely cover the core 240 (or to cover an upper surface and both sides of the core 240).

In the conventional PLC, lower and upper clads have the same width as a substrate (in the direction parallel to a substrate surface). However, in the present invention, the clad 230 has a smaller width than the substrate 220. The width of the clad 230 can be adjusted in a range for minimizing the leakage loss of light traveling into the core 240. This width adjustment can be implemented through a conventional photolithography process. When the width of the clad 230 is very narrow, a degree in which light traveling into the core 240 is leaked to the clad 230 can increase.

The optical protection layer 250 is stacked on the substrate 220 and the clad 230 to completely cover the clad 230, and is made of a material for absorbing light leaked from the core 240 to the clad 230. It is preferred that the optical protection layer 250 absorbs light of a desired wavelength (specifically, an infrared wavelength band), has electrical insulation, and meets the reliability for an optical device.

Methods for forming the optical protection layer 250 will now be exemplarily described hereinafter.

A first method involves coating a black resin for light absorption on the clad 230 and the substrate 220.

A second method involves coating a photoresist on the clad 230 and the substrate 220 and performing exposure and development processes to remove unnecessary parts using a photolithography process.

A third method involves depositing an optical absorption material on the clad 230 and the substrate 220 using a flame hydrolysis deposition (FHD) or chemical vapor deposition (CVD) process, and removing unnecessary parts using a photolithography process.

The optical protection layer 250 absorbs the light leaked from the core 240 to the clad 230 and prevents the crosstalk when the leakage light is integrated, reflected, or scattered, then is input to the PD 270 (or another active device).

Referring back to FIG. 3, the first optical signal has a wavelength of 1310 nm and the second optical signal has a wavelength of 1550 nm. The second optical signal input to the core 240 through an external optical fiber passes through the thin film filter 280 and is input to the PD 270. The PD 270 performs an O/E conversion of the second optical signal input and detects an electrical signal. The first optical signal output from the LD 260 is reflected by the thin film filter 280 and is output to the external optical fiber.

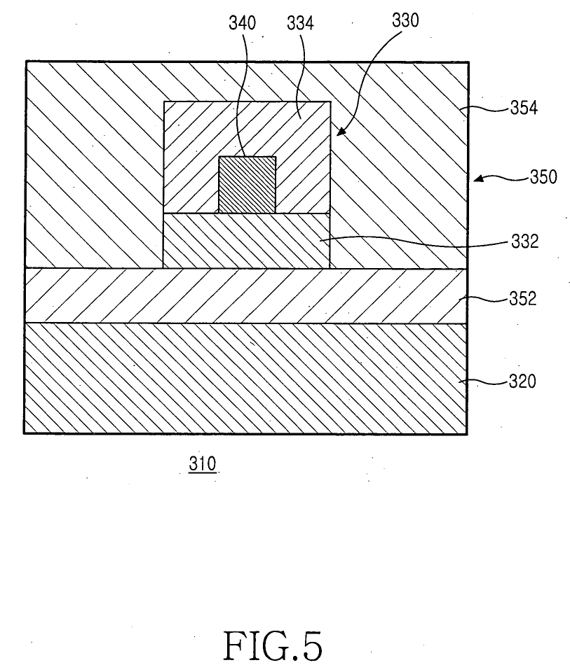

FIG. 5 is a sectional view illustrating a PLC in accordance with another embodiment of the present invention.

As shown, the PLC 310 is provided with a substrate 320, a core 340 serving as a light propagation medium, a clad 330, stacked on the core 340, for completely covering the core 340, and an optical protection layer 350, stacked on the clad 330, for completely covering the clad 330. As the structure of the PLC 310 is similar to that of the PLC of FIG. 4, a repeated description is omitted to avoid redundancy.

The substrate 320 has a flat board shape and may be a conventional semiconductor substrate.

The core 340 is stacked on a lower clad 332 and serves as a light propagation medium. The core 340 is made of a material with low optical loss characteristics.

The clad 330 is stacked on a lower protection layer 352 to completely cover (or surround) the core 340 and includes lower and upper clads 332 and 334. To confine the light within the core 340, the lower and upper clads 332 and 334 have a lower refractive index than the core 340. The lower clad 332 is stacked on the lower protection layer 352, and the core 340 is stacked on the lower clad 332. The upper clad 334 is stacked on the core 340 and the lower clad 332 to completely cover the core 340.

The optical protection layer 350 is stacked on the clad 330 to completely cover (or surround) the clad 330, and includes lower and upper protection layers 352 and 354. The optical protection layer 350, the clad 330, and the core 340 are stacked on the substrate 320. The optical protection layer 350 is made of a material for absorbing the light leaked from the core 340 to the clad 330. It is preferred that the optical protection layer 350 absorbs the light of a desired wavelength, has electrical insulation, and meets the reliability for an optical device.

As is apparent from the above description, the present invention provides a planar lightwave circuit and an integrated optical circuit using the same that cover a clad using an optical protection layer, thereby effectively intercepting the light leaked from a core to the clad and suppressing the crosstalk in the integrated optical circuit.

While the embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. A planar lightwave circuit, comprising:
a core serving as a light propagation medium;
a clad having lower and upper portions, stacked on the core, for covering the core to confine light within the core, the clad having a lower refractive index than the core; and
an optical protection layer, stacked on the clad, for covering the clad, the optical protection layer being made of a material for absorbing the light leaked from the core to the clad.

2. The planar lightwave circuit of claim 1, further comprising a substrate for mounting the core, the clad and the optical protection layer.

3. The planar lightwave circuit of claim 2, wherein the clad has a smaller width than the substrate and completely surrounds the core.

4. The planar lightwave circuit of claim 3, wherein the optical protection layer completely surrounds the clad.

5. The planar lightwave circuit of claim 1, wherein the optical protection layer is formed by: coating a black resin for a light absorption on the clad and the substrate;
coating a photoresist on the clad and the substrate and removing unnecessary parts therefrom using a photolithography process; and
depositing an optical absorption material on the clad and the substrate using a flame hydrolysis deposition (FHD) or chemical vapor deposition (CVD) process, and removing unnecessary parts therefrom using a photolithography process.

6. An integrated optical circuit, comprising:
a planar lightwave circuit comprising at least one active device integrated therein, the planar lightwave circuit comprising:
a core serving as a light propagation medium;
a clad, stacked on the core, for covering the core to confine light within the core, the clad having a lower refractive index than the core; and
an optical protection layer, stacked on the clad, for covering the clad, the optical protection layer being made of a material for absorbing the light leaked from the core to the clad.

7. The integrated optical circuit of claim 6, further comprising a substrate for mounting the core, the clad and the optical protection layer.

8. The integrated optical circuit of claim 7, wherein the clad has a smaller width than the substrate and completely surrounds the core.

9. The integrated optical circuit of claim 8, wherein the optical protection layer completely surrounds the clad.

10. The integrated optical circuit of claim 6, wherein the optical protection layer is formed by:
coating a black resin for a light absorption on the clad and the substrate;
coating a photoresist on the clad and the substrate and removing unnecessary parts therefrom using a photolithography process; and
depositing an optical absorption material on the clad and the substrate using a flame hydrolysis deposition (FHD) or chemical vapor deposition (CVD) process, and removing unnecessary parts therefrom using a photolithography process.

11. A method for providing a planar lightwave circuit, comprising:
providing a core;
providing a clad having a lower refractive index than the core, stacked on the core, for covering the core to confine light within the core, the clad having a lower refractive index than the core; and
providing an optical protection layer, stacked on the clad, for covering the clad, wherein the optical protection layer being made of a material for absorbing the light leaked from the core to the clad.

12. The method of claim 11, further comprising providing a substrate for mounting the core, the clad and the optical protection layer.

13. The method of claim 12, wherein the clad has a smaller width than the substrate and completely surrounds the core.

14. The method of claim 13, wherein the optical protection layer completely surrounds the clad.

15. The method of claim 11, wherein the optical protection layer is formed by:
coating a black resin for a light absorption on the clad and the substrate;
coating a photoresist on the clad and the substrate and removing unnecessary parts therefrom using a photolithography process; and
depositing an optical absorption material on the clad and the substrate using a flame hydrolysis deposition (FHD) or chemical vapor deposition (CVD) process, and removing unnecessary parts therefrom using a photolithography process.
